(19) United States
(12) Patent Application Publication
(10) Pub. No.: US 2016/0219363 A1
(43) Pub. Date: Jul. 28, 2016

(54) DIFFRACTION BLADE FOR LOUDSPEAKER UNIT

(71) Applicant: Robert Bosch GmbH, Stuttgart (DE)

(72) Inventor: Mark DeLay, Saint Paul, MN (US)

(21) Appl. No.: 14/662,990

(22) Filed: Mar. 19, 2015

Related U.S. Application Data
(60) Provisional application No. 62/107,223, filed on Jan. 23, 2015.

(51) Int. Cl. H04R 1/30; G10K 13/00

(52) U.S. Cl. CPC H04R 1/30; G10K 13/00

(57) ABSTRACT

A diffraction blade includes a diffraction blade body and a diffraction blade edge for widening an acoustic planar wave entering a waveguide horn having a subtended angle. The diffraction blade is disposed at a specific focal length from an acoustic diffraction slit of an acoustic generator to effectively form subdivided slits. The divided waveforms created by the diffraction blade have the same phase/time at the diffraction blade edge and as they recombine at the end of the diffraction blade body. Thus, the divided wave forms are mirror images of each other. The focal length, along with the width and horizontal length of the diffraction blade, are selected to ensure that the phase and direction of the acoustic planar waveforms from the subdivided slits match when recombined and exiting from a subtended angle of the waveguide horn as a widened acoustic planar wave.

### RELATED APPLICATIONS

This application claims priority from U.S. provisional application 62/107,223, filed Jan. 23, 2015, the entire content of which is hereby incorporated by reference.

### BACKGROUND

The present invention relates to a diffraction blade that adjusts coverage of an acoustic wave output by an acoustic wave generator. More specifically, the present invention widens the horizontal acoustic radiation pattern of a plane wave entering the input of a waveguide horn having a known subtended angle.

Transducer units (compression drivers, woofers, etc.) are coupled to a waveguide (horn) for multiple reasons. One reason is to control the pattern of sound radiation. A second reason is to improve the efficiency by getting a better acoustical loading from electrical input to acoustical output.

The goal of an effective sound reinforcement system is to confine the sound radiation from a loudspeaker (or an array of loudspeakers) to an audience area. Thus, loudspeakers having different radiation patterns are required. Waveguides are used to control that radiation pattern (i.e., the angle over which the sound radiates from the waveguide) by using different geometries for an input, an output and a transition from input to output.

Techniques for designing the geometry of a waveguide or a horn are known by those skilled in the art of waveguide design, and will not be included in this discussion. However, an explanation of basic waveguide properties is necessary to understand this invention.

A waveguide has an input and output. A transducer is coupled to the waveguide input. Most loudspeaker compression drivers have a round output. As waveguides are designed to control the sound independently in the horizontal and vertical planes, they are usually rectangular at their output. The input of the waveguide may be round or rectangular. If not rectangular, a transition section may be required to convert the transducer round output to the waveguide rectangular input. The long dimension of the rectangular input is usually in the vertical plane, while the short dimension is usually in the horizontal plane.

In the long dimension (the vertical plane), the transition section may have complex internal detail to shape the acoustic wave and, if so, is often called an acoustic wave generator.

A waveguide can only confine sound waves. Thus, the sound entering the input must radiate into the waveguide at a wide angle so that the waveguide can confine the sound to the intended angle of radiation. To achieve this, the input must be smaller than the wavelength of sound over which the transducer and waveguide will operate.

An acoustic radiation angle at the input is inversely proportional to the frequency of the sound. As the frequency increases, the radiation angle at the input narrows. For a given waveguide input width, the radiation angle decreases with increasing frequency. For a wider waveguide radiation angle, the waveguide input must be smaller. As the wavelengths for high frequencies are so small, making the input small enough to acoustically fill the waveguide for wider coverage angles is a challenge.

### SUMMARY

An object of this invention is to utilize an acoustic diffraction blade to disrupt the acoustic wavefront at the input to a waveguide horn and widen the radiation angle output therefrom. The main mechanism for this effect is sound wave diffraction around the diffraction blade. The result is that the diffraction blade extends the high-frequency limit, allowing a wider radiation angle to be held at a higher frequency, resulting in even coverage in the audience area.

Another object of this invention utilizes an acoustic diffraction blade in front of the output of an acoustic wave generator to diffract the sound wave to widen the radiation angle output therefrom, allowing a wider radiation angle to be held at a higher frequency, resulting in even coverage in the audience area. Very short wavelengths (high frequencies) cause a coverage angle to decrease.

The diffraction blade is utilized when very wide horizontal coverage patterns are required at higher frequencies, and is omitted when narrow coverage patterns are required and the diffraction blade is not necessary. In one embodiment, the invention is a diffraction blade that provides constant horizontal coverage for acoustic waves that approach 20 kHz.

In one embodiment, the invention provides an elongate diffraction blade for widening an acoustic radiation pattern of an acoustic planar wave entering a waveguide horn comprising: an elongate diffraction blade body having a length; a diffraction blade edge having a linear edge that extends substantially an entire length of the elongate diffraction blade body; and at least two legs for securing the elongate diffraction blade to at least one of an acoustic wave generator and a waveguide horn, wherein the elongate diffraction blade body is symmetrical with respect to either side of the diffraction blade edge for dividing an acoustic planar wave into two co-linear waveforms.

In one embodiment, at least two legs of the elongate diffraction blade comprise end legs disposed at corresponding ends of the elongate diffraction blade body, the end legs projecting outwardly in a direction generally corresponding to the direction of the diffraction blade edge and transverse to the length of the elongate diffraction blade body. In another embodiment, the end legs extend outwardly beyond the diffraction blade edge and include a mounting face disposed outwardly beyond the length of the diffraction blade body for securing the diffraction blade

In another embodiment, at least two legs of the elongate diffraction blade comprise elongate central legs disposed near a center of the elongate diffraction blade body, the elongate central legs projecting outwardly in a direction transverse to the length of the elongate diffraction blade body and beyond the diffraction blade edge, the elongate central legs being symmetric with respect to the diffraction blade edge.

In one embodiment, the elongate diffraction blade for widening an acoustic radiation pattern of an acoustic planar wave entering a waveguide horn from an acoustic wave generator has the at least two legs configured for securing the elongate diffraction blade to an acoustic wave generator with the diffraction blade body disposed within a waveguide horn.

In another embodiment, the invention provides a loudspeaker unit comprising: a transducer unit for outputting an acoustic wave; an acoustic wave generator including a substantially rectangular acoustic diffraction slit having an aperture width at an output end, the acoustic wave generator having an input end configured to receive the acoustic wave from an output end of the transducer unit, the acoustic wave generator configured to output an acoustic planar wave from the substantially rectangular acoustic diffraction slit; a waveguide horn for receiving the acoustic planar wave, the waveguide horn having an input end and an output end; and an elongate diffraction blade comprising an elongate diffraction blade body and a diffraction blade edge extending substantially an entire length of the elongate diffraction blade body, the elongate diffraction blade disposed within the waveguide horn and oriented so that the diffraction blade edge is facing the substantially rectangular acoustic diffraction slit of the acoustic wave generator, wherein the elongate diffraction blade disposed in the waveguide horn diffracts the acoustic planar wave that is output from the substantially rectangular acoustic diffraction slit.

In one embodiment, the diffraction blade is disposed along a central axis of the acoustic wave generator, the elongate diffraction blade providing two co-linear waveforms formed by the diffraction blade edge dividing the acoustic planar wave, the elongate diffraction blade body disposed along the central axis, and between sidewalls of the waveguide horn.

In another embodiment, the output end of the waveguide horn has a substantially rectangular shape to output an acoustic planar wave, and a chamber of the waveguide horn expands in width symmetrically from the input end toward the output end.

In one embodiment, the elongate diffraction blade has selected dimensions and is disposed a preselected distance from the substantially rectangular acoustic diffraction slit based on the aperture width of the substantially rectangular acoustic diffraction slit, wherein the dimensions and location of the elongate diffraction blade widen an acoustic radiation pattern at or near the input of the waveguide horn to extend a high frequency range of the waveguide horn.

In one embodiment, the dimensions of the elongate diffraction blade are defined by the length of the elongate diffraction blade body, a width and a horizontal length of the elongate diffraction blade body, the horizontal length taken from the diffraction blade edge to a point on the elongate diffraction blade body furthest from the diffraction blade edge and the horizontal length is transverse to the length of the elongate diffraction blade.

In another embodiment, the elongate diffraction blade body is symmetrical with respect to either side of the diffraction blade edge for dividing an acoustic planar wave into two co-linear waveforms, and the elongate diffraction blade body has a concave shape at least away from the diffraction blade edge.

In one embodiment, the elongate diffraction blade comprises at least two legs for securing the elongate diffraction blade to at least one of the acoustic wave generator and the waveguide horn. In another embodiment, the at least two legs comprise end legs disposed at corresponding ends of the elongate diffraction blade body, the end legs projecting outwardly in a direction generally corresponding to the direction of the diffraction blade edge and substantially transverse to the length of the elongate diffraction blade body. In one embodiment, the end legs extend outwardly beyond the diffraction blade edge and include a mounting face disposed outwardly beyond the length of the elongate diffraction blade body, the mounting face contacting the acoustic wave generator to secure the elongate diffraction blade to the acoustic wave generator.

In another embodiment, the at least two legs further comprise two elongate central legs disposed near a center of the elongate diffraction blade body, the two elongate central legs projecting outwardly transverse to the length of the elongate diffraction blade body and beyond the diffraction blade edge, the two elongate central legs being symmetric with respect to the diffraction blade edge, and wherein the two elongate central legs are configured to be disposed in slots of the acoustic wave generator to secure the elongate diffraction blade thereto.

In one embodiment, the at least two legs secure the elongate diffraction blade to the acoustic wave generator with the elongate diffraction blade body disposed within the waveguide horn.

In another embodiment, the at least two legs comprise elongate central legs disposed near a center of the elongate diffraction blade body, the elongate central legs projecting outwardly transverse to the length of the elongate diffraction blade body and beyond the diffraction blade edge, the central legs being symmetric with respect to the diffraction blade edge, and wherein the elongate central legs are configured to be disposed in slots of the acoustic wave generator to secure the elongate diffraction blade thereto.

Other aspects of the invention will become apparent by consideration of the detailed description and accompanying drawings.

### BRIEF DESCRIPTION OF THE DRAWINGS

FIG. 1 shows a perspective view of a diffraction blade.

FIG. 2 shows a top view of the diffraction blade.

FIG. 3 shows a perspective view of a diffraction blade mounted to an acoustic wave generator.

FIG. 4 shows a perspective view of a loudspeaker unit that includes a transducer unit, an acoustic wave generator and a waveguide horn.

FIG. 5 is a front view of the loudspeaker unit.

FIG. 6 is a cross-section view of the loudspeaker unit taken at VI-VI in FIG. 5.

FIG. 7 is an expanded view of the diffraction blade area shown in FIG. 6 that shows the relative dimensions and positions of the diffraction blade body, the acoustic diffraction slit and the waveguide horn.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

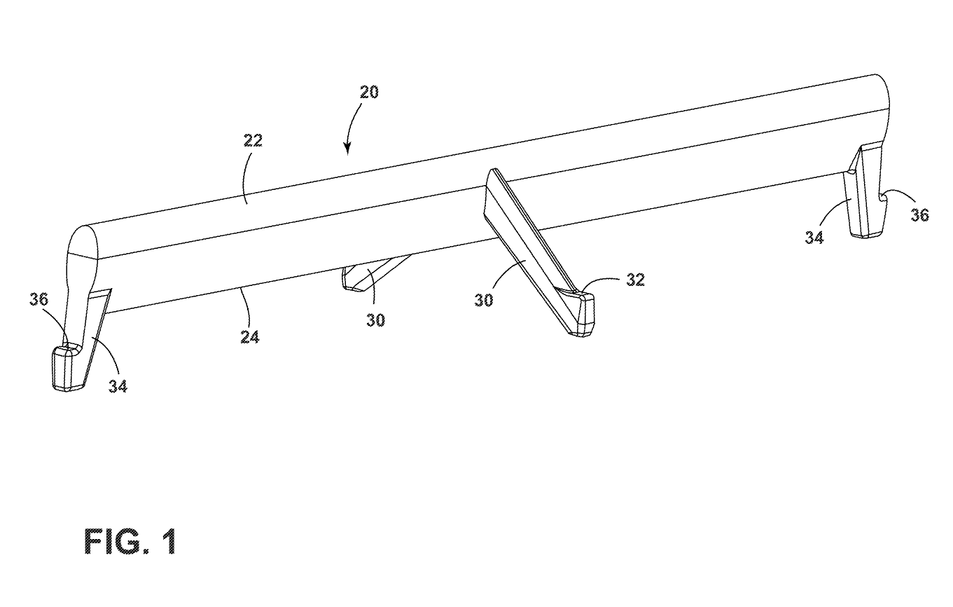

FIG. 1 illustrates an elongate diffraction blade 20 for widening an acoustic radiation pattern of an acoustic planar wave. The elongate diffraction blade 20 includes a diffraction blade body 22 that includes a diffraction blade edge 24 having a linear edge that extends substantially the entire length thereof. The diffraction blade body 22 is symmetrical with respect to either side of the diffraction blade edge 24 for dividing an acoustic planar wave into two co-linear acoustic planar waveforms. Further, the diffraction blade body 22 has a concave shape at least away from the diffraction blade edge 24.

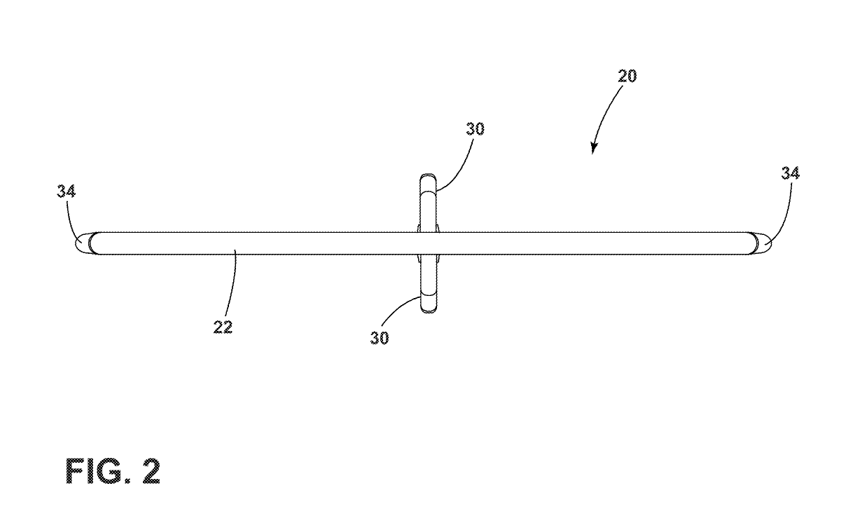

The elongate diffraction blade 20 includes at least two legs, and typically at least two elongate central legs 30 for securing the diffraction blade to at least one of an acoustic wave generator and a waveguide horn. The two elongate central legs 30 are disposed near a center of the elongate diffraction blade body 22 and project outwardly in a direction transverse to the length of the diffraction blade body 22. The elongate central legs 30 extend beyond the diffraction blade edge 24, and the central legs are symmetric with respect to the length of the diffraction blade edge as shown in FIG. 2. The central legs 30 include mounting elements 32 for securing the diffraction blade 20 in slots of an acoustic wave generator.

The diffraction blade 20 includes at least two elongate end legs 34 disposed at the corresponding ends of the elongate diffraction blade body 22. The elongate end legs 34 project outwardly in a direction generally transverse to the length of the elongate diffraction blade body 22 and outwardly beyond the diffraction blade edge 24. Further, the elongate end legs 34 include a mounting face 36 disposed outwardly beyond the length of the diffraction blade body 22 for securing the diffraction blade 20. FIG. 2 shows a top view of the diffraction blade 20 wherein the end legs 34 also project outwardly a small amount beyond the length of the diffraction blade body 22.

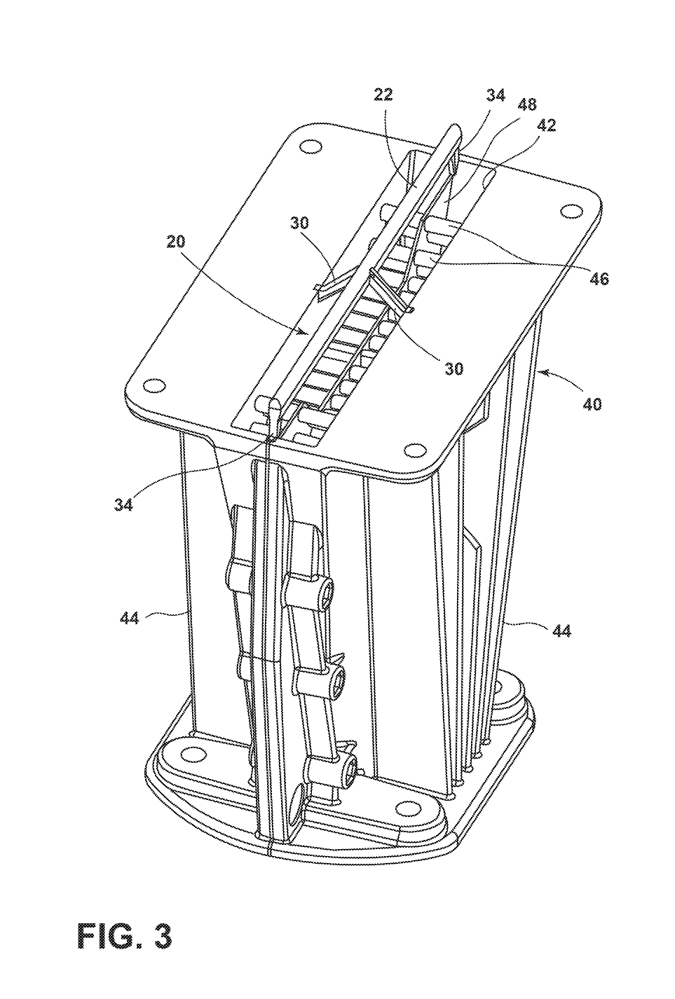

FIG. 3 shows the diffraction blade 20 mounted to an acoustic wave generator 40. The acoustic wave generator 40 includes a substantially rectangular acoustic diffraction slit 42 having an aperture width. The acoustic wave generator 40 is formed in part by two halves 44 that are bolted/screwed or otherwise secured together. In FIG. 3, projections 46 and an optional thin gasket 48 are shown disposed within the acoustic wave generator 40. The acoustic wave generator 40 is similar to the waveguide for shaping sound waves disclosed in commonly owned U.S. patent application Ser. No. 14/525,874, filed Oct. 28, 2014, the disclosure of which is hereby incorporated by reference.

In FIG. 3, a lip (not shown) is formed in the acoustic wave generator 40 at each end of the acoustic diffraction slit 42. When mounted onto the face of the acoustic wave generator 40, the end legs 34 of the diffraction blade 20 flex to allow insertion into the acoustic diffraction slit 42 and then seat at the ends of the diffraction slit with the respective mounting faces 36 in surface to surface contact with the respective lips. Further, the acoustic wave generator 40 includes inwardly opening and facing slots (not shown) disposed on opposing sides of the acoustic diffraction slit 42. The mounting elements 32 of the respective central legs 30 of the diffraction blade 20 are configured to be disposed in slots of the acoustic wave generator 40. Thus, as shown in FIG. 3, the diffraction blade 20 is securely secured to the acoustic wave generator 40, with the diffraction blade body 22 spaced a preselected distance from the acoustic diffraction slit 42.

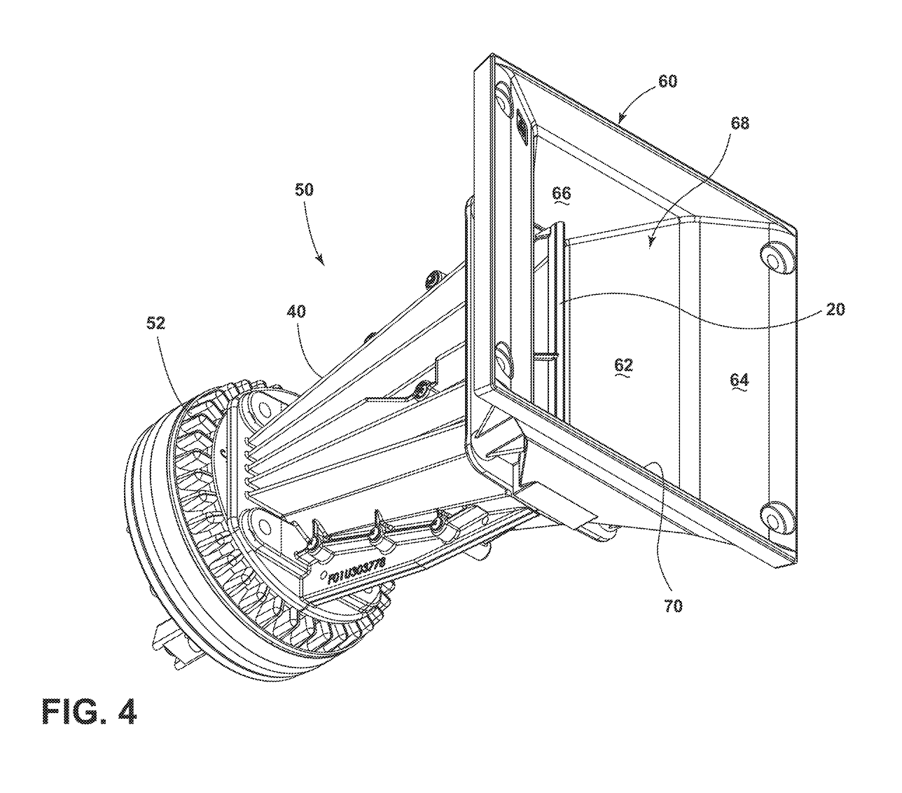

FIG. 4 is a perspective view of a loudspeaker unit 50 that includes a transducer unit 52 that is secured at an output end to an input end of an acoustic wave generator 40. Thus, the acoustic wave generator 40 receives a transducer unit output at the input end thereof. Further, FIG. 4 shows a waveguide horn 60 having an input end secured to an output end of the acoustic wave generator 40 to receive an acoustic planar wave therefrom. As shown in FIG. 4, the waveguide horn 60 has a rectangular shape with first waveguide horn sidewalls 62 and second waveguide horn sidewalls 64. The second sidewalls 64 open at a greater angle than the first sidewalls 62. The sidewalls 62, 64 and waveguide horn end walls 66 form a chamber 68 having a substantially rectangular opening 70 at an output end of the waveguide horn 60 as shown in the embodiment of FIGS. 4-6. The chamber 68 of the waveguide horn 60 expands in width symmetrically from the input end toward the output end thereof.

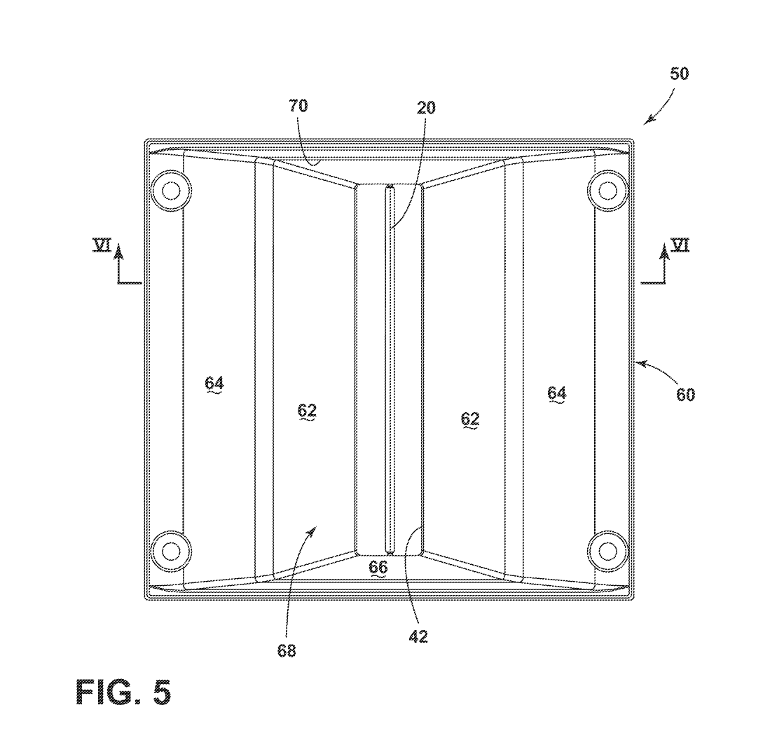

In FIGS. 4 and 5, the diffraction blade 20 extends the entire length of the acoustic diffraction slit 42. For purposes of minimizing the number of details not related to the illustrated invention, the projections, transducer opening, and other elements disposed within the acoustic wave generator 40 and viewable through the acoustic diffraction slit 42 are not shown in FIGS. 5-7.

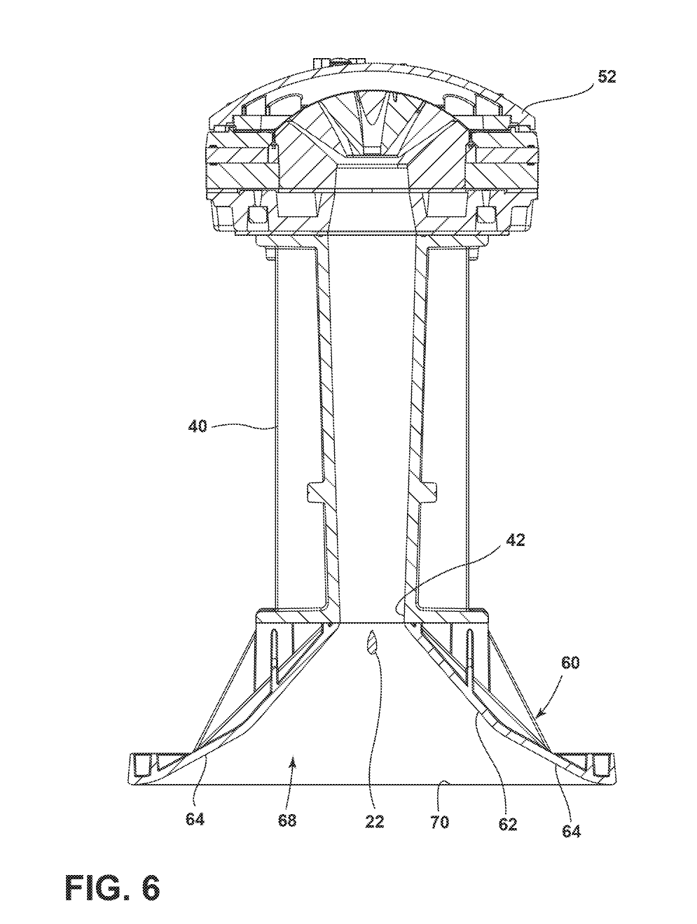

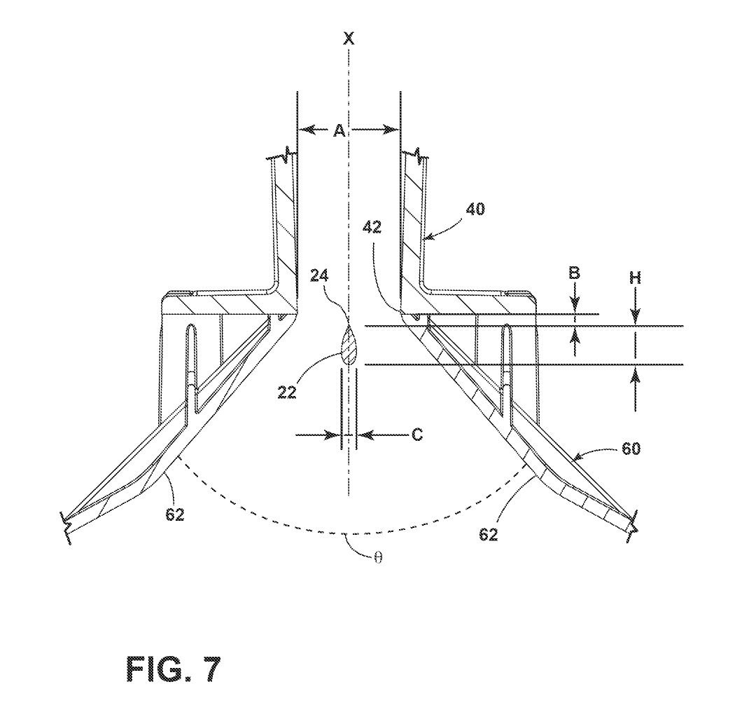

FIG. 6 is a cross-sectional view taken from FIG. 5 showing the relationship between the transducer unit 52, the acoustic wave generator 40, the diffraction blade body 22 and the waveguide horn 60. For purposes of illustration the legs of the diffraction blade 20 are not shown in FIGS. 6 and 7, and thus only the diffraction blade body 22 is shown therein. The shape of the waveguide horn 60 and the specific angles of the sidewalls 62, 64 relative to each other and to the acoustic diffraction slit 42 are shown in FIGS. 6 and 7. FIG. 7 is a blow-up of a portion of the loudspeaker unit 50 taken where the substantially rectangular acoustic diffraction slit 42 opens into the waveguide horn 60 in FIG. 6. Thus, FIG. 7 clearly illustrates the relationship of the diffraction blade body 22 to the substantially rectangular acoustic diffraction slit 42 of the acoustic wave generator 40. Moreover, the fitting of the waveguide horn 60 in alignment with the acoustic diffraction slit 42 of the acoustic wave generator 40 is illustrated.

FIG. 7 also details the relative positions and dimensions of the diffraction blade body 22 relative to the acoustic diffraction slit 42 of the acoustic wave generator 40 and the first sidewalls 62 of the waveguide horn 60. The waveguide horn 60 opens into a first subtended angle θ defined by the sidewalls 62. FIG. 7 shows a central axis X that extends from the acoustic diffraction slit 42 that has an aperture or slit aperture width A. The diffraction blade body 22 is centered on the central axis X and the diffraction blade edge 24 is on the central axis X facing the diffraction slit 42. The diffraction blade body 22 is disposed symmetrically along the central axis X. Thus, the elongate diffraction blade 20 is disposed within the waveguide horn 60 and oriented so that the diffraction blade edge 24 is facing the rectangular acoustic diffraction slit 42 of the acoustic wave generator 40. Further, the diffraction blade edge 24 is spaced a preselected distance or focal length B from the end of the acoustic diffraction slit 42 of the acoustic wave generator 40, whereat the sidewalls 62 of the waveguide horn 60 open at the angle θ. FIG. 7 shows the diffraction blade body 22 having a width C across the opening of the diffraction slit 42 and a horizontal length H. The horizontal length is taken from the diffraction blade edge 24 to a point on the diffraction blade body 22 furthest from the diffraction blade edge and transverse to the length of the diffraction blade 20.

FIG. 7 shows that a substantially rectangular slit input of the waveguide horn 60 fits seamlessly with the rectangular acoustic diffraction slit 42. The acoustic radiation pattern of the wave front emerging from the substantially rectangular acoustic diffraction slit 42 into the waveguide horn 60 is calculated according to diffraction theory. The theory states that the acoustic radiation pattern will decrease as the frequency increases. If the slit aperture width A is too wide, the sound emerging from the slit will be too narrow and will not provide coverage over the entirety of the subtended angle θ of the waveguide horn 60. In practice, this effect occurs at very high audio frequencies (typically above 8 kHz) when the angle θ of the waveguide horn 60 is very wide. Thus, the loudspeaker unit 50 is typically fully operative without the diffraction blade 20 at frequencies below 8 kHz.

To operate the loudspeaker unit 50 at high audio frequencies, the diffraction blade 20 is secured to the acoustic wave generator 40 as shown in FIG. 3 and the waveguide horn 60 is also secured thereto.

Operation

In operation, the diffraction blade body 22 shown in FIG. 7 divides the acoustic planar wave received by the waveguide horn 60 from the acoustic diffraction slit 42 into two slits. The slits are defined by the diffraction blade edge 24 and the diffraction blade body 22 dividing the acoustic wave and the respective first sidewalls 62 of the waveguide horn 60. Thus, two separate slits/paths are provided for the separate acoustic planar waves. While FIG. 7 shows the newly formed slits created by the diffraction blade 20, the slits each extend essentially the entire length of the diffraction blade, and thus are long and narrow. The two slits act as two new independent acoustic sources for acoustic planar wave fronts, and in FIG. 7 are symmetrical and mirror images of each other. The two slits result in two new wave fronts that output from the waveguide horn 60, each having the ability to radiate into a wider subtended angle at a higher frequency because of their reduced width. Thus, the new wave fronts fit the subtended angle θ of the waveguide horn 60 at the higher frequencies.

Desired wave fronts are not easily obtainable throughout the desired frequency range as the presence of the diffraction blade 20 creates unwanted artifacts from the formation of two new wavelets in the form of acoustic interference patterns. These interference patterns are commonly referred to as a “lobing” in the acoustic radiation pattern, and can result in an acoustic radiation pattern that is wider than the subtended angle θ of the waveguide horn 60, causing acoustic reflections off the waveguide horn sidewalls 62, 64. Thus, the various selected dimensions and distances of the diffraction blade 20 are chosen to account for this condition.

The shape, size and position of the diffraction blade 20 are also chosen to avoid astigmatic polar characteristics. Astigmatic behavior results when acoustic waves radiating from the two subdivided slits do not have the same focal length, i.e., they are not in the same plane. Astigmatic behavior will also result if the phase of the acoustic waves that exit the subdivided slits do not match at the point of recombination after the diffraction blade 20.

In order to avoid an astigmatic condition, the first criterion is that the diffraction blade edge 24 must be positioned in the original aperture in equal integer multiples splitting the original aperture into two (or more) evenly spaced slits and be in the same plane so they have the same focal length B including along the length the length of the diffraction blade edge 24. In FIG. 7, one diffraction blade body 22 divides the original input slit aperture width in half, (A/2). Since the two equal subdivided slits are in the same plane perpendicular to the direction of sound propagation, each slit radiates an acoustic wave field having the same energy in the same direction in the same phase. Additional divisions can be accomplished by adding additional diffraction blades as long as the resultant divided acoustic wave fields have the same focal lengths.

The diffraction blade 20 that is introduced into the input aperture of the waveguide horn 60 must have a minimal starting profile, or a sharp narrow diffraction blade edge 24, that offers the least disruption to the entering wave field. The mere presence of the diffraction blade body 22 ensures that diffraction will occur.

A second criterion for the diffraction blade 20 is that the two wave fields that exit the waveguide horn 60 must recombine in a coherent fashion. The focal length B of the diffraction blade 20, the shape of the diffraction blade body 22, the width C, and the horizontal length H of the diffraction blade body are chosen so that: 1) the pressure compression and rarefaction zones for the two exiting or divided waveforms have the same phase/time at the diffraction blade edge 24 and as they recombine at the end of the diffraction blade body 22, and 2) the adjacent edges of the two divided waveforms are collinear (substantially parallel to each other along the axis of the waveguide) as they recombine at the end of the diffraction blade body 22. The result is that the two divided waveforms are mirror images of each other, in phase and collinear at the seam of the recombination. Thus, the diffraction blade 20 disposed along the central axis X, and the sidewalls 62 of the waveguide horn 60, divides a single wave at the diffraction blade edge 24 into two separate waves. The shape of the diffraction blade 20 from the edge of the blade 24 to the end of the body 22 over the length H shapes the individual waveforms so that they are in phase and collinear when they recombine to approximate into a single waveform radiating at a wider angle than the single wave before it was divided. Accordingly, the diffraction blade 20 has selected dimensions and is disposed a preselected distance from the substantially rectangular acoustic diffraction slit 42 based on the aperture width A.

The sidewalls 64 do not have a major effect on the planar acoustic wave output by the waveguide horn 60 at the frequencies of interest to the diffraction blade 20. At lower frequencies, however, the sidewalls 64 have a significant effect on the planar wave output from the waveguide horn 60.

Another criterion is the value of the aspect ratio of the diffraction blade 20, which is determined by the width C vs. the horizontal length H thereof. The value of the aspect ratio is directly dependent on the slit aperture width A, the subtended angle of the waveguide horn θ, and the desired frequency range of operation. Thus, the dimensions and spacing are changed to obtain a desired frequency range of operation for the diffraction blade 20.

The benefits of the diffraction blade 20 widening the acoustic radiation pattern at or near the input of the waveguide horn 60 are realized over a limited frequency range (approximately one half octave). At lower frequencies below its operating range of 8 Khz in one embodiment, presence of the diffraction blade 20 is negligible in the operation of the loudspeaker unit 50. At higher frequencies above its operating range, such as above 20 Khz, the diffraction blade 20 introduces destructive interference patterns that cause lobing and decreased on-axis sensitivity. In instances where the selected dimensions B, C and H are not carefully chosen, destructive interference patterns occur.

In conclusion, the selected dimensions B, C and H, along with the location of the diffraction blade 20, are carefully chosen to widen the acoustic radiation pattern at or near the input of the waveguide horn 60, allowing the waveguide horn to be fully illuminated by the acoustic wave pattern, and extending the high-frequency range of operation of the waveguide horn 60. Installing the diffraction blade 20 enables a loudspeaker unit 50 to output acoustic waves at wider angles at higher frequencies compared to the loudspeaker unit without the diffraction blade. Thus, the diffraction blade 20 extends a high frequency range of the waveguide horn 60.

In another embodiment, the diffraction blade 20 mounts to the waveguide horn 60 adjacent the input end thereof. Besides the mounting structure with the legs 30, 34 for the diffraction blade 20 set forth above, other mounting embodiments are contemplated. Such embodiments include fasteners, legs that snap into apertures, and adhesives to secure the diffraction blade to one of the acoustic wave generator 40 and the waveguide horn 60. In another embodiment, the diffraction blade 20 is formed monolithically with the waveguide horn 60.

In some embodiments, the diffraction blade 20 is a molded plastic material. The material generally is not completely rigid as some flexibility under a load is provided for the legs 30, 34 to assist in mounting the diffraction blade 20 to the acoustic wave generator 40.

While a single diffraction blade 20 is shown, other embodiments provide multiple diffraction blades spaced and in parallel to divide an acoustic wave into multiple wave fronts. The paths provided by multiple diffraction blades each have the same properties B, C, H.

Thus, the invention provides, among other things, a diffraction blade 20 that is provided with a loudspeaker unit 50 to enable the output of acoustic waves at wider angles at higher frequencies. Various features and advantages of the invention are set forth in the following claims.

What is claimed is:

1. An elongate diffraction blade for widening an acoustic radiation pattern of an acoustic planar wave entering a waveguide horn comprising:
an elongate diffraction blade body having a length;
a diffraction blade edge having a linear edge that extends substantially an entire length of the elongate diffraction blade body; and
at least two legs for securing the elongate diffraction blade to at least one of an acoustic wave generator and a waveguide horn,
wherein the elongate diffraction blade body is symmetrical with respect to either side of the diffraction blade edge for dividing an acoustic planar wave into two co-linear waveforms.

2. The elongate diffraction blade according to claim 1, wherein the at least two legs comprise end legs disposed at corresponding ends of the elongate diffraction blade body, the end legs projecting outwardly in a direction generally corresponding to the direction of the diffraction blade edge and transverse to the length of the elongate diffraction blade body.

3. The elongate diffraction blade according to claim 2, wherein the end legs extend outwardly beyond the diffraction blade edge and include a mounting face disposed outwardly beyond the length of the diffraction blade body for securing the diffraction blade.

4. The elongate diffraction blade according to claim 1, wherein the at least two legs comprise elongate central legs disposed near a center of the elongate diffraction blade body, the elongate central legs projecting outwardly in a direction transverse to the length of the elongate diffraction blade body and beyond the diffraction blade edge, the elongate central legs being symmetric with respect to the diffraction blade edge.

5. The elongate diffraction blade according to claim 1 for widening an acoustic radiation pattern of an acoustic planar wave entering a waveguide horn from an acoustic wave generator, wherein the at least two legs are configured for securing the elongate diffraction blade to an acoustic wave generator with the diffraction blade body disposed within a waveguide horn.

6. A loudspeaker unit comprising:
a transducer unit for outputting an acoustic wave;
an acoustic wave generator including a substantially rectangular acoustic diffraction slit having an aperture width at an output end, the acoustic wave generator having an input end configured to receive the acoustic wave from an output end of the transducer unit, the acoustic wave generator configured to output an acoustic planar wave from the substantially rectangular acoustic diffraction slit;
a waveguide horn for receiving the acoustic planar wave, the waveguide horn having an input end and an output end; and
an elongate diffraction blade comprising an elongate diffraction blade body and a diffraction blade edge extending substantially an entire length of the elongate diffraction blade body, the elongate diffraction blade disposed within the waveguide horn and oriented so that the diffraction blade edge is facing the substantially rectangular acoustic diffraction slit of the acoustic wave generator,
wherein the elongate diffraction blade disposed in the waveguide horn diffracts the acoustic planar wave that is output from the substantially rectangular acoustic diffraction slit.

7. The loudspeaker unit according to claim 6, wherein the diffraction blade is disposed along a central axis of the acoustic wave generator, the elongate diffraction blade providing two co-linear waveforms formed by the diffraction blade edge dividing the acoustic planar wave, the elongate diffraction blade body disposed along the central axis, and between sidewalls of the waveguide horn.

8. The loudspeaker unit according to claim 6, wherein the output end of the waveguide horn has a substantially rectangular shape to output an acoustic planar wave, and wherein a chamber of the waveguide horn expands in width symmetrically from the input end toward the output end.

9. The loudspeaker unit according to claim 6, wherein the elongate diffraction blade has selected dimensions and is disposed a preselected distance from the substantially rectangular acoustic diffraction slit based on the aperture width of the substantially rectangular acoustic diffraction slit, wherein the dimensions and location of the elongate diffraction blade widen an acoustic radiation pattern at or near the input of the waveguide horn to extend a high frequency range of the waveguide horn.

10. The loudspeaker unit according to claim 9, wherein the dimensions of the elongate diffraction blade are defined by the length of the elongate diffraction blade body, a width and a horizontal length of the elongate diffraction blade body, the horizontal length taken from the diffraction blade edge to a point on the elongate diffraction blade body furthest from the diffraction blade edge and the horizontal length is transverse to the length of the elongate diffraction blade.

11. The loudspeaker unit according to claim 10, wherein the elongate diffraction blade body is symmetrical with respect to either side of the diffraction blade edge for dividing an acoustic planar wave into two co-linear waveforms, and wherein the elongate diffraction blade body has a concave shape at least away from the diffraction blade edge.

12. The loudspeaker unit according to claim 6, wherein the elongate diffraction blade comprises at least two legs for securing the elongate diffraction blade to at least one of the acoustic wave generator and the waveguide horn.

13. The loudspeaker unit according to claim 12, wherein the at least two legs comprise end legs disposed at corresponding ends of the elongate diffraction blade body, the end legs projecting outwardly in a direction generally corresponding to the direction of the diffraction blade edge and substantially transverse to the length of the elongate diffraction blade body.

14. The loudspeaker unit according to claim 13, wherein the end legs extend outwardly beyond the diffraction blade edge and include a mounting face disposed outwardly beyond the length of the elongate diffraction blade body, the mounting face contacting the acoustic wave generator to secure the elongate diffraction blade to the acoustic wave generator.

15. The loudspeaker unit according to claim 14, wherein the at least two legs further comprises two elongate central legs disposed near a center of the elongate diffraction blade body, the two elongate central legs projecting outwardly transverse to the length of the elongate diffraction blade body and beyond the diffraction blade edge, the two elongate central legs being symmetric with respect to the diffraction blade edge, and wherein the two elongate central legs are configured to be disposed in slots of the acoustic wave generator to secure the elongate diffraction blade thereto.

16. The loudspeaker unit according to claim 6, wherein at least two legs secure the elongate diffraction blade to the acoustic wave generator with the elongate diffraction blade body disposed within the waveguide horn.

17. The loudspeaker unit according to claim 12, wherein the at least two legs comprise elongate central legs disposed near a center of the elongate diffraction blade body, the elongate central legs projecting outwardly transverse to the length of the elongate diffraction blade body and beyond the diffraction blade edge, the central legs being symmetric with respect to the diffraction blade edge, and wherein the elongate central legs are configured to be disposed in slots of the acoustic wave generator to secure the elongate diffraction blade thereto.

18. The loudspeaker unit according to claim 7, wherein the two co-linear waveforms formed by the diffraction blade edge dividing the acoustic planar wave are mirror images of each other.
